(19) United States
(12) Patent Application Publication
(10) Pub. No.: US 2025/0001353 A1
(43) Pub. Date: Jan. 2, 2025

(54) ACIDIC GAS RECOVERY APPARATUS AND ACIDIC GAS RECOVERY METHOD

(71) Applicants: TOSHIBA ENERGY SYSTEMS & SOLUTIONS CORPORATION, Kawasaki-shi (JP); INPEX CORPORATION, Tokyo (JP)

(72) Inventors: Takashi OGAWA, Yokohama Kanagawa (JP); Shota INOUE, Yokohama Kanagawa (JP); Yosuke SANO, Yokohama Kanagawa (JP); Yutaka OYAMADA, Arakawa Tokyo (JP); Yasushi YAMAMOTO, Yokohama Kanagawa (JP)

(21) Appl. No.: 18/754,423

(22) Filed: Jun. 26, 2024

(30) Foreign Application Priority Data
Jun. 27, 2023 (JP) 2023-105427

(51) Int. Cl. B01D 53/14; B01D 53/18; B01D 53/26; F01D 15/10

(52) U.S. Cl. CPC B01D 53/1425; B01D 53/1462; B01D 53/1468; B01D 53/1475; B01D 53/18; B01D 53/265; F01D 15/10

(57) ABSTRACT

In one embodiment, an acidic gas recovery apparatus includes an absorber to be supplied with a first gas including an acidic gas, cause an absorption liquid to absorb the acidic gas, and discharge the liquid that has adsorbed the acidic gas, and a second gas including the first gas from which the acidic gas has been removed, which are separated by a first separator. The apparatus further includes an evaporator to heat this liquid to release the acidic gas and steam, and discharge the liquid from which the acidic gas and the steam have been released, and a third gas including the acidic gas and the steam, which are separated by a second separator. The apparatus further includes a cooler to cool this third gas to condense the steam, and discharge the acidic gas and condensed water, which are separated by a third separator.

### CROSS-REFERENCE TO RELATED APPLICATION

This application is based upon and claims the benefit of priority from the prior Japanese Patent Application No. 2023-105427, filed on Jun. 27, 2023, the entire contents of which are incorporated herein by reference.

### FIELD

Embodiments described herein relate to an acidic gas recovery apparatus and an acidic gas recovery method.

### BACKGROUND

As methods for separating and recovering an acidic gas from an acidic gas-containing gas, chemical absorption, physical absorption, solid absorption, membrane separation, physical adsorption, cryogenic methods and the like have been known. Examples of the acidic gas include carbon dioxide (CO₂), hydrogen sulfide (H₂S) and the like. When these methods are adopted, the pressure of the acidic gas-containing gas needs to be equal to or greater than the normal pressure. When the pressure of the acidic gas-containing gas is a negative pressure, the acidic gas-containing gas needs to be pressurized (compressed) to increase its pressure to be equal to or greater than the normal pressure, prior to the separation and recovery of the acidic gas.

### BRIEF DESCRIPTION OF THE DRAWINGS

FIG. 1 is a schematic view illustrating the configuration of an acidic gas recovery apparatus of a first embodiment;

FIG. 2 is a schematic view illustrating the configuration of the acidic gas recovery apparatus of a second embodiment;

FIG. 3 is a schematic view illustrating the configuration of the acidic gas recovery apparatus of a third embodiment; and

FIG. 4 is a schematic view illustrating the configuration of the acidic gas recovery apparatus of a fourth embodiment.

### DETAILED DESCRIPTION

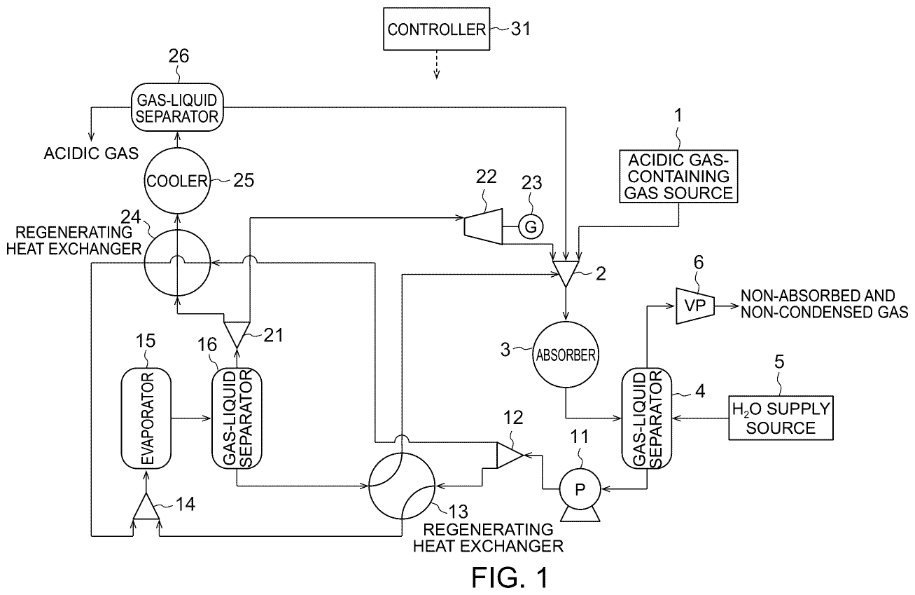

Embodiments will now be explained with reference to the accompanying drawings. In FIGS. 1 to 4, the same components are assigned the same reference signs and the overlapping descriptions will be omitted.

When an acidic gas-containing gas is pressurized, it is required to secure a pressurizing power for pressurizing the acidic gas-containing gas. For example, for separation and recovery of an acidic gas using an acidic gas recovery apparatus, a pressurizing power is externally supplied to the acidic gas recovery apparatus. In this case, reducing the necessary pressurizing power and generating the pressurizing power in the acidic gas recovery apparatus are desired. However, either case has a problem of requiring the pressurizing power for the acidic gas-containing gas for the separation and recovery of the acidic gas.

In one embodiment, an acidic gas recovery apparatus includes an absorber configured to be supplied with a first gas including an acidic gas from a gas source, cause an absorption liquid to absorb the acidic gas included in the first gas, and discharge the absorption liquid that has adsorbed the acidic gas, and a second gas including the first gas from which the acidic gas has been removed, and a first gas-liquid separator configured to separate the absorption liquid and the second gas that are discharged from the absorber. The apparatus further includes an evaporator configured to heat the absorption liquid discharged from the first gas-liquid separator to release the acidic gas and steam from the absorption liquid, and discharge the absorption liquid from which the acidic gas and the steam have been released, and a third gas including the acidic gas and the steam, and a second gas-liquid separator configured to separate the absorption liquid and the third gas that are discharged from the evaporator. The apparatus further includes a cooler configured to cool the third gas discharged from the second gas-liquid separator to condense the steam included in the third gas, and discharge the acidic gas included in the third gas, and condensed water generated through the condensation of the steam, and a third gas-liquid separator configured to separate the condensed water and the acidic gas that are discharged from the cooler.

### First Embodiment

FIG. 1 is a schematic view illustrating the configuration of an acidic gas recovery apparatus of a first embodiment.

The acidic gas recovery apparatus of the present embodiment includes an acidic gas-containing gas source 1, a mixer 2, a negative pressure condensation absorber 3, a gas-liquid separator 4, a water supply source 5, a vacuum pump 6, a pump 11, a divider 12, a regenerating heat exchanger 13, a mixer 14, an evaporator 15, a gas-liquid separator 16, a divider 21, a turbine 22, an electric generator 23, a regenerating heat exchanger 24, a cooler 25, a gas-liquid separator 26 and a controller 31. The gas-liquid separators 4, 16 and 26 represent first, second and third gas-liquid separators, respectively. The regenerating heat exchangers 13 and 24 represent first and second heat exchangers, respectively.

The acidic gas-containing gas source 1 supplies an acidic gas-containing gas. Hereinafter, the acidic gas-containing gas source 1 is simply represented as a “gas source 1.” An acidic gas included in the acidic gas-containing gas is, for example, carbon dioxide, hydrogen sulfide or the like. The acidic gas-containing gas is the gas to be treated by the acidic gas recovery apparatus of the present embodiment. The acidic gas recovery apparatus of the present embodiment separates and recovers the acidic gas from the acidic gas-containing gas. The acidic gas-containing gas represents a first gas. The gas source 1 obtains, as the acidic gas-containing gas, a discharge gas discharged from, for example, a thermal power plant. The gas source 1 of the present embodiment supplies the acidic gas-containing gas having a negative pressure. The gas source 1 may be installed outside the acidic gas recovery apparatus of the present embodiment.

The negative pressure condensation absorber 3 is supplied with the acidic gas-containing gas from the gas source 1 via the mixer 2. Hereinafter, an “absorber 3” represents the negative pressure condensation absorber 3. As will be described later, the mixer 2 is supplied with the gas from the gas source 1, the turbine 22, and the gas-liquid separator 26 and discharges a mixed gas obtained in the mixer 2 to the absorber 3. The acidic gas-containing gas is included in the mixed gas. The absorber 3 causes an absorption liquid as a lean solution to absorb the acidic gas included in the mixed gas. The absorption liquid is a liquid having an acidic gas absorbing function and is also referred to as an acidic gas absorption liquid. The absorption liquid is, for example, an amine-based absorption liquid. The absorber 3 discharges the absorption liquid as a rich solution that has absorbed the acidic gas, and a treated gas, which is a non-absorbed and non-condensed gas obtained by removing the acidic gas from the mixed gas. The non-absorbed and non-condensed gas is a gas including components that have been neither absorbed in the absorption liquid nor condensed into a liquid, of the mixed gas components. The non-absorbed and non-condensed gas represents a second gas.

The gas-liquid separator 4 is supplied with a fluid including the absorption liquid and the non-absorbed and non-condensed gas from the absorber 3, and separates the fluid into the absorption liquid and the non-absorbed and non-condensed gas. The gas-liquid separator 4 is further supplied with water from the water supply source 5. As a result, the non-absorbed and non-condensed gas is mixed with saturated steam evaporated from the water. The supply amount of water from the water supply source 5 to the gas-liquid separator 4 is controlled based on the height of the liquid level in the gas-liquid separator 4. The water supply source 5 may be installed outside the acidic gas recovery apparatus of the present embodiment.

The vacuum pump 6 is supplied with the non-absorbed and non-condensed gas (including the aforementioned saturated steam) discharged from the gas-liquid separator 4 and releases the non-absorbed and non-condensed gas to the atmosphere.

The pump 11 pressurizes the absorption liquid discharged from the gas-liquid separator 4 and transfers the absorption liquid to the evaporator 15 via the divider 12, the regenerating heat exchangers 13 and 24, and the mixer 14. The divider 12 divides the absorption liquid discharged from the gas-liquid separator 4 into the absorption liquid flowing into the regenerating heat exchanger 13 and the absorption liquid flowing into the regenerating heat exchanger 24. The regenerating heat exchanger 13 performs heat exchange between the absorption liquid directed from the divider 12 toward the mixer 14 and the absorption liquid directed from the gas-liquid separator 16 toward the mixer 2. As a result, the former absorption liquid is heated, while the latter absorption liquid is cooled. The mixer 14 mixes the absorption liquid supplied from the regenerating heat exchanger 13 and the absorption liquid supplied from the regenerating heat exchanger 24 and discharges the mixed absorption liquid to the evaporator 15.

The evaporator 15 heats the absorption liquid supplied from the mixer 14 and releases the acidic gas and the steam from the absorption liquid. The evaporator 15 discharges the absorption liquid as the lean solution from which the acidic gas and the steam have been released, and the mixed gas including the acidic gas and the steam. The mixed gas represents a third gas.

The gas-liquid separator 16 is supplied with a fluid including the absorption liquid and the mixed gas from the evaporator 15 and separates the fluid into the absorption liquid and the mixed gas. The absorption liquid is supplied to the mixer 2 via the regenerating heat exchanger 13 and is supplied to the absorber 3, together with the gas in the mixer 2. Meanwhile, the mixed gas is supplied to the divider 21.

The divider 21 divides the mixed gas discharged from the gas-liquid separator 16 into the mixed gas flowing into the turbine 22 and the mixed gas flowing into the regenerating heat exchanger 24. The turbine 22 is supplied with the mixed gas from the divider 21, is driven by the mixed gas, and discharges the mixed gas to the mixer 2. The electric generator 23 is driven by the turbine 22 to generate power.

The regenerating heat exchanger 24 performs heat exchange between the mixed gas directed from the divider 21 toward the cooler 25 and the absorption liquid directed from the divider 12 toward the mixer 14. As a result, the mixed gas is cooled, while the absorption liquid is heated.

The cooler 25 cools the mixed gas supplied from the regenerating heat exchanger 24 and condenses the steam included in the mixed gas. The cooler 25 discharges the acidic gas included in the mixed gas and condensed water generated through condensation of the steam.

The gas-liquid separator 26 is supplied with a fluid including the acidic gas and the condensed water from the cooler 25, and separates the fluid into the acidic gas and the condensed water. In this manner, the acidic gas is recovered by the acidic gas recovery apparatus of the present embodiment. In the present embodiment, the pressure of the acidic gas-containing gas supplied from the gas source 1 is a negative pressure, while the pressure of the recovered acidic gas is equal to or greater than the normal pressure. Meanwhile, remaining acidic gas that has not been recovered and the condensed water are supplied to the mixer 2 and are supplied to the absorber 3, together with the gas and the absorption liquid in the mixer 2.

The controller 31 controls various operations of the acidic gas recovery apparatus of the present embodiment. For example, the controller 31 controls the supply amount of water from the water supply source 5 to the gas-liquid separator 4 based on the height of the liquid level in the gas-liquid separator 4.

As noted above, the acidic gas recovery apparatus of the present embodiment recovers the acidic gas included in the acidic gas-containing gas using the absorber 3, the gas-liquid separator 4, the evaporator 15, the gas-liquid separator 16, the cooler 25, and the gas-liquid separator 26. Specifically, the acidic gas recovery apparatus of the present embodiment recovers the acidic gas by causing the absorption liquid to absorb the acidic gas, releasing the acidic gas and the steam from the absorption liquid, and condensing the steam.

Therefore, the present embodiment makes it possible to recover the acidic gas from the acidic gas-containing gas without requiring pressurization of the acidic gas-containing gas. This eliminates the necessity of securing the pressurizing power for pressurizing the acidic gas-containing gas. Further, the present embodiment makes it possible to recover a high-purity acidic gas with the use of the absorption liquid for the acidic gas recovery. Furthermore, the present embodiment makes it possible to generate power by the electric generator 23, with the turbine 22 driven by the mixed gas obtained from the acidic gas-containing gas.

Note that the pressure of the acidic gas-containing gas supplied from the gas source 1 is a negative pressure in the present embodiment, but may not be a negative pressure. For example, when the pressure of the acidic gas-containing gas supplied from the gas source 1 is higher than the outlet pressure of the turbine 22, the acidic gas-containing gas from the gas source 1 may be depressurized by a pressure-reducing valve and/or an expansion turbine and then supplied to the absorber 3. The pressure-reducing valve and/or the expansion turbine may be disposed upstream of the turbine 22. When the acidic gas recovery apparatus of the present embodiment includes a plurality of turbines 22, the pressure-reducing valve and/or the expansion turbine may be disposed between the turbines 22. This makes it possible to recover the pressure energy of the acidic gas-containing gas. When the acidic gas-containing gas is supplied upstream of the turbine 22 or between the plurality of turbines 22, the acidic gas-containing gas may be supplied without passing the pressure-reducing valve and/or the expansion turbine. Further, when the turbine 22 is a multi-stage turbine, the acidic gas-containing gas may be supplied to a middle stage of the multi-stage turbine. The balance between the pressure of the acidic gas-containing gas and the pressure of the site where the acidic gas-containing gas is supplied determines which way of the above is adopted.

Further, the gas source 1 may obtain the acidic gas-containing gas from a facility or a site other than a thermal power plant. For example, the gas source 1 may obtain the acidic gas-containing gas using PSA, TSA, PTSA, or a membrane separation apparatus. In addition, the acidic gas-containing gas may also be a non-condensable gas from geothermal power generation, a discharge gas from a natural gas field, a discharge gas from a plant, or an exhaust gas from an incineration site.

Further, an absorbing agent in the absorption liquid may be, for example, an alkalescent substance. Examples of such a substance may include ammonia (NH₃), amines, amine acid salts, silicone oil having an amino group, bicarbonate and the like. The absorption liquid may include only one of these substances alone or may include two or more of these substances as a mixture. Examples of a solvent of the absorption liquid may include water, silicone oil, ethylene glycol, a fluorine compound and the like. The absorption liquid may include only one of these solvents alone or may include two or more of these solvents as a mixture.

Furthermore, under some operating conditions, the acidic gas recovery apparatus of the present embodiment may not use the divider 12, the regenerating heat exchanger 24, and/or the cooler 25. In addition, the acidic gas recovery apparatus of the present embodiment may adjust the moisture amount in the acidic gas to be recovered, by controlling the temperature of the regenerating heat exchanger 24 and/or the cooler 25.

The recovered acidic gas may be, for example, stored or used as raw material for various processes such as organic synthesis and methane synthesis.

Further, the acidic gas may be of any type. For example, the acidic gas may include both carbon dioxide and hydrogen sulfide or may include only either one of carbon dioxide and hydrogen sulfide.

### Second Embodiment

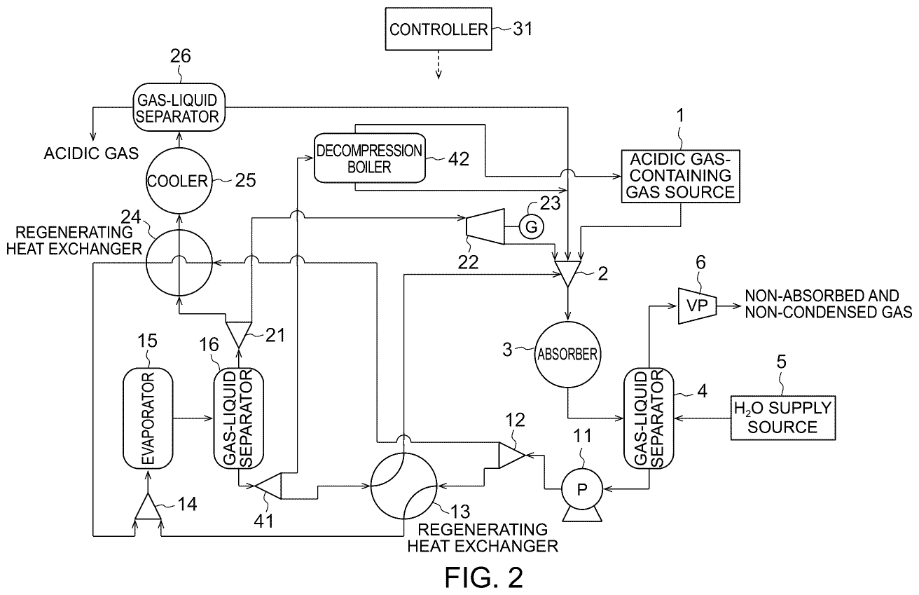

FIG. 2 is a schematic view illustrating the configuration of the acidic gas recovery apparatus of a second embodiment.

The acidic gas recovery apparatus of the present embodiment additionally includes a divider 41 and a decompression boiler 42 to the constituent elements of the acidic gas recovery apparatus of the first embodiment.

The divider 41 divides the absorption liquid discharged from the gas-liquid separator 16 into the absorption liquid flowing into the decompression boiler 42 and the absorption liquid flowing into the regenerating heat exchanger 13. The regenerating heat exchanger 13 of the present embodiment performs heat exchange between the absorption liquid directed from the divider 12 toward the mixer 14 and the absorption liquid directed from the divider 41 toward the mixer 2.

The decompression boiler 42 performs decompression boiling on the absorption liquid supplied from the divider 41, and releases low-pressure steam from the absorption liquid. The decompression boiler 42 supplies part of the steam to the gas source 1 and supplies remaining part of the steam to the mixer 2. The former steam is used in the gas source 1, as a heat source for heating the acidic gas-containing gas. Meanwhile, the latter steam is supplied to the absorber 3, together with the gas and the absorption liquid in the mixer 2.

The present embodiment makes it possible to use the steam generated by the decompression boiler 42, as a heat source.

### Third Embodiment

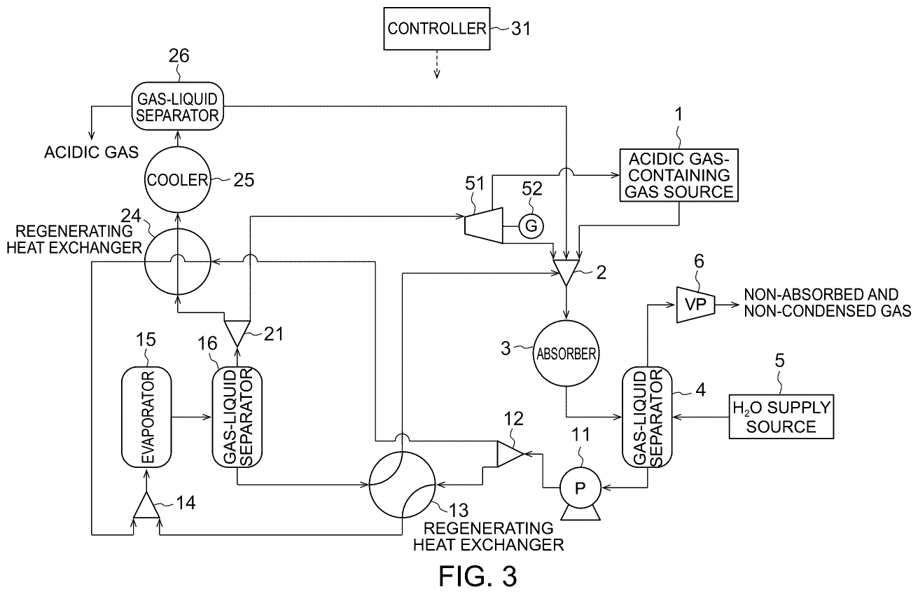

FIG. 3 is a schematic view illustrating the configuration of the acidic gas recovery apparatus of a third embodiment.

The acidic gas recovery apparatus of the present embodiment has a same structure of the first embodiment, but the turbine 22 and the electric generator 23 are replaced with an extraction turbine 51 and an electric generator 52.

The divider 21 of the present embodiment divides the mixed gas discharged from the gas-liquid separator 16 into a mixed gas flowing into the extraction turbine 51 and a mixed gas flowing into the regenerating heat exchanger 24. The extraction turbine 51 is supplied with the mixed gas from the divider 21, is driven by the mixed gas, and discharges the mixed gas to the mixer 2. The electric generator 52 is driven by the extraction turbine 51 to generate power.

The extraction turbine 51 includes a gas inlet for introducing the mixed gas from the divider 21, a gas outlet for discharging the mixed gas to the mixer 2, and an extraction port provided between the gas inlet and the gas outlet. In the present embodiment, the mixed gas in the extraction turbine 51 is extracted through the extraction port and is supplied to the gas source 1. The mixed gas is used in the gas source 1, as a heat source for heating the acidic gas-containing gas.

The present embodiment makes it possible to use the mixed gas extracted from the extraction turbine 51, as a heat source. The present embodiment makes it possible to provide the heat source without using the decompression boiler 42, and this makes it possible to increase the flow rate of the mixed gas supplied to the extraction turbine 51 as compared to the flow rate of the mixed gas supplied to the turbine 22 of the second embodiment.

### Fourth Embodiment

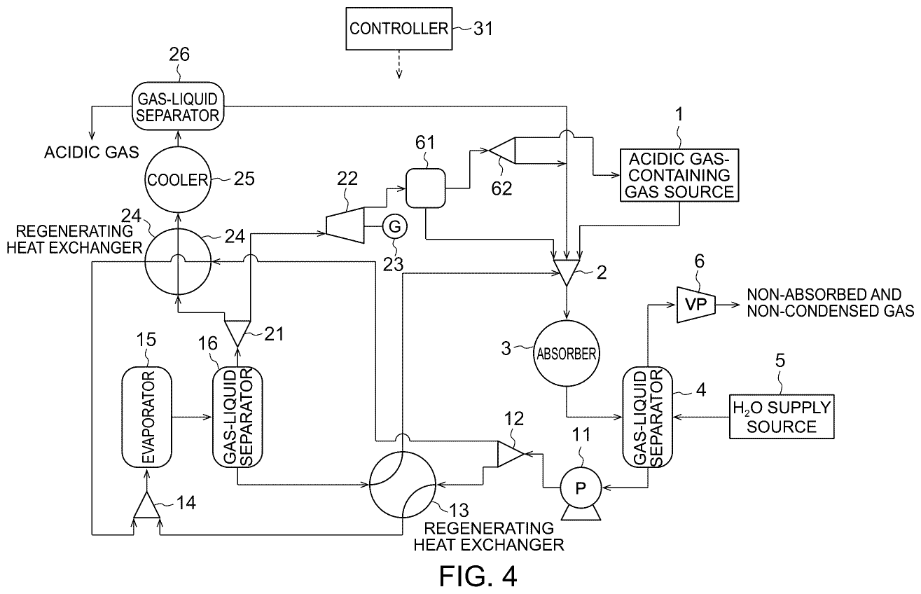

FIG. 4 is a schematic view illustrating the configuration of the acidic gas recovery apparatus of a fourth embodiment.

The acidic gas recovery apparatus of the present embodiment includes a gas-liquid separator 61 and a divider 62 in addition to the constituent elements of the acidic gas recovery apparatus of the first embodiment. The gas-liquid separator 61 is an example of a fourth gas-liquid separator.

The turbine 22 of the present embodiment is supplied with the mixed gas from the divider 21, is driven by the mixed gas, and discharges the mixed gas to the gas-liquid separator 61. The gas-liquid separator 61 separates the mixed gas into a gas phase and a liquid phase. The liquid phase is supplied to the mixer 2 and is supplied to the absorber 3, together with the gas and the absorption liquid in the mixer 2. An example of the liquid phase is condensed water obtained through condensation of the steam in the turbine 22. Meanwhile, the gas phase is supplied to the divider 62.

The divider 62 divides the gas phase discharged from the gas-liquid separator 61 into a gas phase flowing into the gas source 1 and a gas phase flowing into the mixer 2. The former gas phase is used in the gas source 1, as a heat source for heating the acidic gas-containing gas. Meanwhile, the latter gas phase is supplied to the absorber 3, together with the gas and the absorption liquid in the mixer 2.

The present embodiment makes it possible to use the gas phase discharged from the gas-liquid separator 61, as a heat source. The present embodiment makes it possible to provide the heat source without using the decompression boiler 42, and this makes it possible to increase the flow rate of the mixed gas supplied to the turbine 22 of the present embodiment as compared to the flow rate of the mixed gas supplied to the turbine 22 of the second embodiment.

Note that the acidic gas recovery apparatus of the present embodiment may include the evaporator 15 (initial-stage evaporator) and a next-stage evaporator. The next-stage evaporator heats the condensed water supplied from the cooler 25, and releases the acidic gas and the steam from the condensed water. The acidic gas released from the condensed water is an acidic gas component dissolved in the condensed water in the cooler 25. In this case, the turbine 22 may be supplied with the mixed gas including the acidic gas and the steam from the next-stage evaporator to be driven by the mixed gas. This makes it possible to reduce the acidic gas concentration in the mixed gas discharged from the turbine 22.

Such a next-stage evaporator may be applied to the acidic gas recovery apparatus of the third embodiment. In this case, the extraction turbine 51 may be supplied with the mixed gas including the acidic gas and the steam from the next-stage evaporator to be driven by the mixed gas. This makes it possible to reduce the acidic gas concentration in the mixed gas extracted and discharged from the extraction turbine 51.

While certain embodiments have been described, these embodiments have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from the spirit of the inventions. The accompanying claims and their equivalents are intended to cover such forms or modifications as would fall within the scope and spirit of the inventions.

1. An acidic gas recovery apparatus comprising:
an absorber configured to be supplied with a first gas including an acidic gas from a gas source, cause an absorption liquid to absorb the acidic gas included in the first gas, and discharge the absorption liquid that has adsorbed the acidic gas, and a second gas including the first gas from which the acidic gas has been removed;
a first gas-liquid separator configured to separate the absorption liquid and the second gas that are discharged from the absorber;
an evaporator configured to heat the absorption liquid discharged from the first gas-liquid separator to release the acidic gas and steam from the absorption liquid, and discharge the absorption liquid from which the acidic gas and the steam have been released, and a third gas including the acidic gas and the steam;
a second gas-liquid separator configured to separate the absorption liquid and the third gas that are discharged from the evaporator;
a cooler configured to cool the third gas discharged from the second gas-liquid separator to condense the steam included in the third gas, and discharge the acidic gas included in the third gas, and condensed water generated through the condensation of the steam; and
a third gas-liquid separator configured to separate the condensed water and the acidic gas that are discharged from the cooler.

2. The apparatus of claim 1, wherein the third gas discharged from the second gas-liquid separator is divided into the third gas supplied to the cooler, and the third gas supplied to the absorber.

3. The apparatus of claim 1, wherein the condensed water discharged from the third gas-liquid separator is supplied to the absorber.

4. The apparatus of claim 1, further comprising a first heat exchanger configured to perform heat exchange between the absorption liquid directed from the first gas-liquid separator toward the evaporator and the absorption liquid directed from the second gas-liquid separator toward the absorber.

5. The apparatus of claim 1, further comprising a second heat exchanger configured to perform heat exchange between the absorption liquid directed from the first gas-liquid separator toward the evaporator and the third gas directed from the second gas-liquid separator toward the cooler.

6. The apparatus of claim 1, further comprising:
a turbine configured to be driven by the third gas discharged from the second gas-liquid separator; and
an electric generator configured to be driven by the turbine.

7. The apparatus of claim 6, wherein the third gas discharged from the turbine is supplied to the absorber.

8. The apparatus of claim 1, wherein the absorber is a negative pressure condensation absorber.

9. The apparatus of claim 1, wherein the acidic gas includes carbon dioxide and/or hydrogen sulfide.

10. The apparatus of claim 1, further comprising a boiler configured to perform decompression boiling on the absorption liquid discharged from the second gas-liquid separator to release steam from the absorption liquid, and supply the steam to the gas source.

11. The apparatus of claim 10, wherein the boiler further supplies the steam to the absorber.

12. The apparatus of claim 6, wherein the third gas extracted from the turbine is supplied to the gas source.

13. The apparatus of claim 6, further comprising a fourth gas-liquid separator configured to separate the third gas discharged from the turbine into a gas phase and a liquid phase, and supply the gas phase to the gas source.

14. The apparatus of claim 13, wherein the liquid phase discharged from the fourth gas-liquid separator is supplied to the absorber.

15. An acidic gas recovery method comprising:
supplying an absorber with a first gas including an acidic gas from a gas source, and causing, in the absorber, an absorption liquid to absorb the acidic gas included in the first gas, the absorber discharging the absorption liquid that has adsorbed the acidic gas, and a second gas including the first gas from which the acidic gas has been removed;
separating, by a first gas-liquid separator, the absorption liquid and the second gas that are discharged from the absorber;
heating, in an evaporator, the absorption liquid discharged from the first gas-liquid separator to release the acidic gas and steam from the absorption liquid, the evaporator discharging the absorption liquid from which the acidic gas and the steam have been released, and a third gas including the acidic gas and the steam;
separating, by a second gas-liquid separator, the absorption liquid and the third gas that are discharged from the evaporator;
cooling, in a cooler, the third gas discharged from the second gas-liquid separator to condense the steam included in the third gas, the cooler discharging the acidic gas included in the third gas, and condensed water generated through the condensation of the steam; and
separating, by a third gas-liquid separator, the condensed water and the acidic gas that are discharged from the cooler.
